(19) United States
(12) Patent Application Publication
(10) Pub. No.: US 2007/0150699 A1
(43) Pub. Date: Jun. 28, 2007

(54) Firm partitioning in a system with a point-to-point interconnect

(76) Inventors: Ioannis T. Schoinas, Portland, OR (US); Doddaballapur N. Jayasimha, Sunnyvale, CA (US); Eric Delano, Fort Collins, CO (US); Allen Baum, Palo Alto, CA (US); Akhilesh Kumar, Sunnyvale, CA (US); Steven S. Chang, Portland, OR (US); Suresh Chittor, Portland, OR (US); Kenneth C. Creta, Gig Harbor, WA (US); Stephen R. Van Doren, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/321,213

(22) Filed: Dec. 28, 2005

(51) Int. Cl. G06F 15/00

(52) U.S. Cl. 712/13

(57) ABSTRACT

Methods and apparatuses for firm partitioning of a computing platform.

### TECHNICAL FIELD

Embodiments of the invention relate to computing architectures. More particularly, embodiments of the invention relate to partitioning of computing platforms.

### BACKGROUND

Logical partitions may be created on a computer system that divide processors, memory and/or other resources into multiple sets of resources that may be operated independently of each other. Each partition may have its own instance of an operating system and applications. Partitions may be used for different purposes, for example, a database operation may be supported by one partition and another partition on the same computer system may support a client/server operation.

In general, there are currently two categories of partitioning, which are hard physical partitioning and software partitioning. Platforms that implement hard physical partitioning schemes transparently support multiple operating systems at a coarse granularity. Platforms that implement software partitioning schemes such as logical partitioning require operating system changes to redefine the boundary between the operating system and the platform, which may not be practical in many situations. Platforms that implement software partitioning schemes such as virtual partitioning require a significantly complex, fragile and often expensive software layer to create virtual partitions.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of an electronic system that may support firm partitioning.

FIG. 2 is a flow diagram of one embodiment of message control in a system supporting firm partitioning.

FIG. 3a is a conceptual illustration of one embodiment of a message header the may carry a partition identifier in an address field.

FIG. 3b is a conceptual illustration of one embodiment of a message header having a field to carry a partition identifier.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are various architectures that may support firm partitioning that may extend the concept of hard physical partitioning at finer granularity levels in a transparent fashion without requiring operating system changes or a complex software layer. Firm partitioning may allow support for more hardware partitions in a given system or may allow hardware partitioning in platforms with a limited number of distinct components, as is the case in low-end server or client platforms. This technique becomes increasingly important as the industry transitions to multi-core processors that incorporate sufficient processing resources on a single die to readily support multiple operating system instances.

As described in greater detail below, a single component may assign a portion of its resources to different partitions. Accordingly, a large number of partitions may be supported in a given platform independent of the number of distinct components that comprise the platform. Therefore, the number of hardware partitions supported may be increased for high-end platforms and/or hardware partitioning in platforms such low-end servers or client devices may be provided.

Firm partitioning, as described below, includes a concept by which a system interconnect may support firm partitioning in a platform with point-to-point links. Using prior art techniques, support for finer forms of partitioning without operating system modifications or a complex virtualization layer has not been provided. Hardware partitioning schemes, on the other hand, in the prior art are not able to allocate resources at the granularity of cores or I/O ports.

Conceptually, firm partitioning may be considered a form of hardware partitioning. Firm partitioning may offer the same programming model to system software as a hard physical partition or an unpartitioned platform. Distinctions may only visible to configuration firmware and system management. Firm partitioning may rely more on configuration firmware than hard physical partitions. For example, while hard physical partitions may be configured by service processor or configuration firmware, firm partitions may require configuration firmware to ensure programming model isolation (e.g., independent partition reset may not be fully supported by hardware).

In one embodiment, firm partitioning may result in an execution environment that the operating system cannot distinguish from the full platform and provides programming model isolation. In one embodiment, an operating system running on one firm partition may not be able to affect the operation of an operating system running on another firm partition. Each firm partition may be able to boot an operating system independent of other firm partitions.

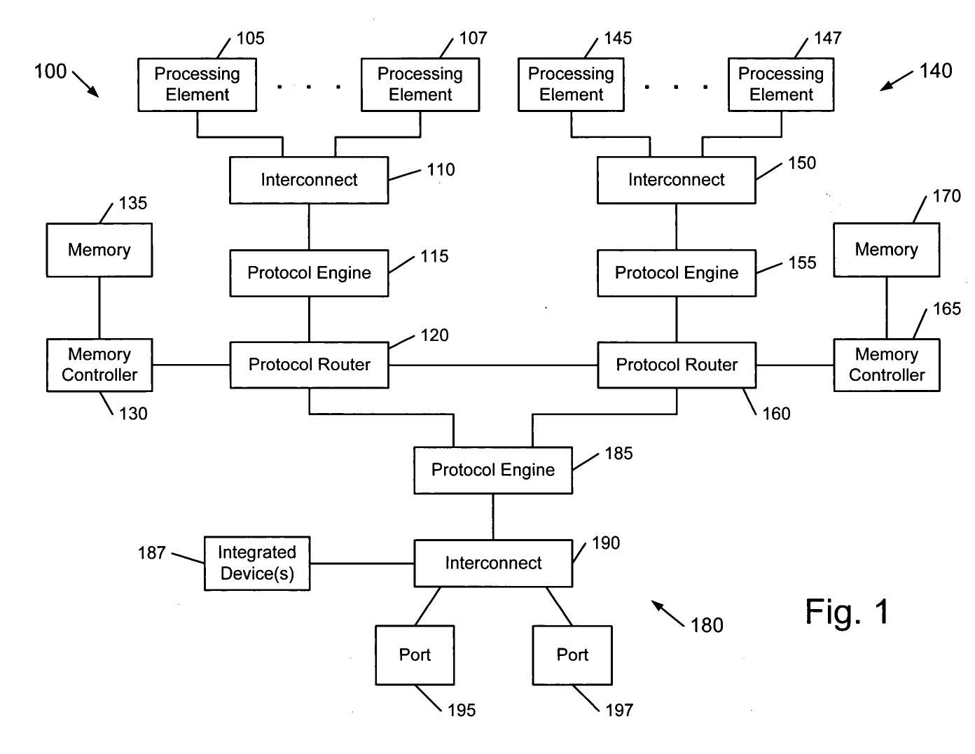

FIG. 1 is a block diagram of an electronic system that may support firm partitioning. The example of FIG. 1 is intended to be an abstract representation of some of the architectural blocks of a system in which firm partitioning may be supported. Any number of processing elements, interconnects, memory, etc may be supported.

In one embodiment, any number of resources (e.g., processing elements, input/output hubs) may be interconnected via point-to-point links that may be used to transport coherent and/or non-coherent requests and responses. In one embodiment, a link protocol may be used to communicate the coherent and/or non-coherent requests and responses.

The example of FIG. 1 includes three modules (100, 140, 180), each of which may have one or more resources that may be coupled to communicate with other resources included in the same or other modules. Resources of each module may independently be assigned to one or more partitions. Module 100 may, for example, include any number of processing elements (e.g., 105, 107), which may be processing cores, co-processors, or any other type of processing resource. The processing elements may be coupled with interconnect 110, which may function to couple the processing elements with protocol engine 115.

Protocol engine 115 may operate to translate requests and responses between the coherency protocol utilized by interconnect 110 and the coherency protocol utilized by the point-to-point links that may be used to interconnect multiple modules. In one embodiment, protocol engine 115 may be coupled with protocol router 120, which may forward messages based on external protocol destination node identifiers included in the messages.

In one embodiment, routing by interconnect 110 may be performed using the destination node identifier that may be included in request, snoop and/or response messages. In one embodiment, a processor, input/output hub, or other module component may have multiple node identifiers and routing tables that may be configured to forward messages with different node identifiers to the same destination. In one embodiment, protocol router 120 may also be coupled with memory controller 130 and coordinate coherency protocol actions for cache lines stored in memory 135.

Similarly, module 140 may, for example, include any number of processing elements (e.g., 145, 147), which may be processing cores, co-processors, or any other type of processing resource. The processing elements may be coupled with interconnect 150, which may function to couple the processing elements with protocol engine 155.

Protocol engine 155 may operate to translate requests and responses between the coherency protocol utilized by interconnect 150 and the coherency protocol utilized by the point-to-point links that may be used to interconnect multiple modules. In one embodiment, protocol engine 155 may be coupled with protocol router 160, which may forward messages based on external protocol destination node identifiers included in the messages.

As described above, routing by interconnect 150 may be performed using the destination node identifier that may be included in request, snoop and/or response messages. In one embodiment, protocol router 160 may also be coupled with memory controller 165 and coordinate coherency protocol actions for cache lines stored in memory 170. Protocol router 160 may be coupled with protocol router 120 via a point-to-point link.

In one embodiment, module 180 may include protocol engine 185 that may be coupled with protocol router 120 via a first point-to-point link. Protocol engine 185 may also be coupled with protocol router 160 via a second point-to-point link. Protocol engine 185 may be coupled with interconnect 190, which may operate in a similar manner as interconnect 110 and interconnect 150 discussed above. Interconnect 190 may be coupled with any number of ports (195, 197), which may include, for example, PCI or PCI Express ports. Interconnect 190 may also be coupled with any number of integrated device 187, including, for example, integrated circuits, etc.

PCI refers to the Peripheral Component Interconnect system that allows system components to be interconnected. Various PCI standards documents are available from the PCI Special Interest Group of Portland, Oregon. The various characteristics of PCI interfaces are well known in the art.

As described in greater detail below, the resources illustrated in FIG. 1 may be partitioned using the firm partitioning techniques described herein. Firm partitioning may allow greater flexibility in the use of the resources than previous partitioning techniques.

Other embodiments may also be supported. For example, each processing element may have a corresponding protocol with multiple protocol engines coupled with a protocol router. As another example, a single, centrally connected protocol router may be coupled with multiple protocol routers and/or protocol engines to provide a centralized routing configuration.

Partitioning allows a set of computing resources to be isolated and dedicated to a corresponding operating system instance. Using firm partitioning as described herein a resource may serve more than one partition. This is not possible using the hard and soft partitioning techniques available previously.

In one embodiment, protocol routers may be configured so that components of a partition are not physically connected with each other. In order for these components to communicate with each other, traffic may flow through routers that may be located on dies of resources corresponding to a different partition. In one embodiment, firm partitioning may be supported in which resources (e.g., processing cores, memory, PCI Express ports, integrated devices) of a component may be assigned to different partitions.

In one embodiment firm partitioning is supported by associating sufficient information with messages flowing over the internal and external interconnects to logically isolate messages from each partition. The following example, describes a cache coherent request. Other types of messages may be supported similarly.

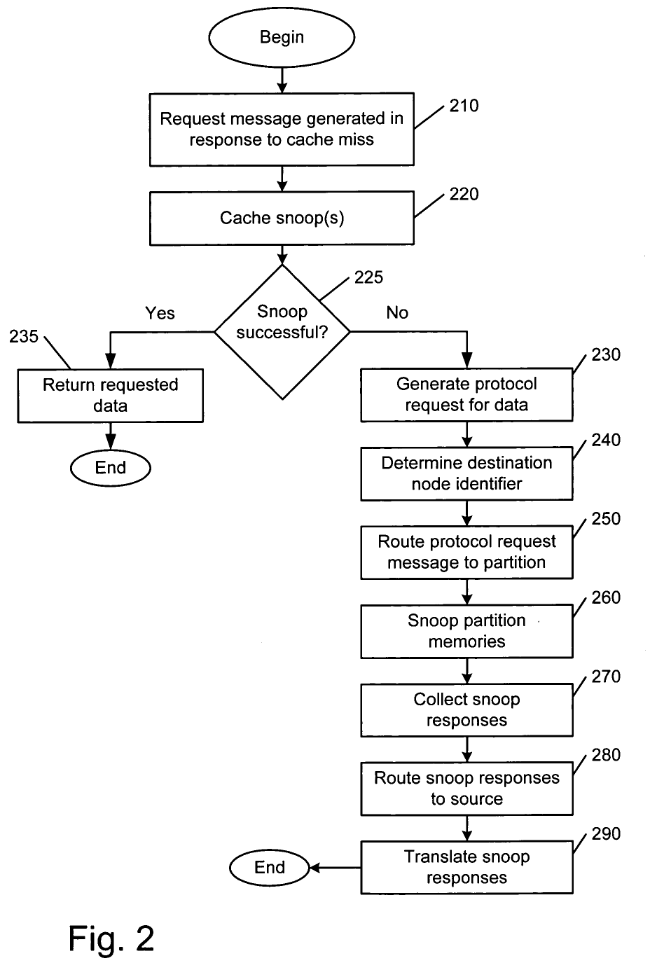

FIG. 2 is a flow diagram of one embodiment of message control in a system supporting firm partitioning. In one embodiment, if a resource (e.g., processing element 105) misses a local, or private, cache a request message may be generated that includes an internal partition identifier, 210. The internal partition identifier may be used by an internal interconnect (e.g., interconnect 110) when routing the request message.

The request message may result in a snoop of private caches of processing element coupled with the interconnect, 220. In one embodiment, only processing elements that share the internal partition identifier are snooped. In one embodiment having shared cache banks, the internal partition identifier may be included in the cache tag.

If the requested data is retrieved via the local snoop, 225, the requested data may be returned to the source using a source internal partition identifier. In one embodiment, if the requested data is not found in a cache of a processing element coupled with the interconnect, 225, a request may be generated to the protocol engine corresponding to the requesting processing element (e.g., protocol engine 115), 230. In one embodiment, the request to the protocol engine also includes the internal partition identifier.

In one embodiment, a protocol engine (e.g., protocol engine 115) may decode an address corresponding to the request message to determine a node identifier for a resource (e.g., memory controller) that “owns” the memory block corresponding to the request, 240. The protocol engine may use the internal partition identifier to identify a different destination per source because the same address may be used by different sources that belong to different partitions to refer to different physical addresses.

In one embodiment a protocol request message may be generated by a protocol engine and forwarded to a protocol router (e.g., protocol router 120). The protocol engine may transform the internal partition identifier to an external partition identifier. The request message with the external partition identifier may be routed to a destination resource, 250. The protocol request message may pass through any number of protocol routers (e.g., protocol router 120 and protocol router 160) depending on the system configuration before reaching the destination.

In one embodiment, a receiving memory controller, or other resource, (e.g., memory controller 165) may transmit snoop requests to all resources that may be snooped for a copy of the requested data, 260. In one embodiment, snoop requests are transmitted to all memory controllers of a partition and may also be transmitted to all input/output hubs that have the ability to cache data blocks.

In one embodiment, the protocol engine may use the external partition identifier to identify the memory block that corresponds to the request address for the partition. In such an embodiment, the external partition identifier may be included in the snoop request messages. In one embodiment, the receiving protocol engines and/or input/output hubs use the external partition identifier to determine the caches or cache banks that belong to the partition and should be snooped. In one embodiment, the external partition identifier may be transformed to an internal partition identifier upon the snoop request being received by an interconnect (e.g., interconnect 150).

Snoop responses corresponding to the snoop request(s) may be collected by a memory controller (e.g., memory controller 165), 270. The snoop responses may be routed to the originating protocol router (e.g., protocol router 120) through any number of protocol routers depending on the configuration of the host system.

When the snoop responses are received by the originating protocol engine (e.g., protocol engine 115), the external response messages may be translated internal interconnect response messages with the corresponding internal partition identifier, 290. The translate messages may be transmitted to the requesting resource (e.g., processing element 105).

The example of FIG. 2 corresponds to a cache coherency request. A similar technique may be applied to requests to memory mapped input/output operations or configuration space operations. In this case, an input/output hub may use the external partition identifier to identify the resource (e.g., PCI Express port, integrated device, chipset register) that corresponds to the partition that generated the request.

In one embodiment, protocol routers and/or other system components may include routing tables that may be used to route messages as described above. The routing tables may allow multiple identifiers to correspond to a single component. This may support sharing of resources between multiple partitions.

For example, a memory controller may belong to multiple partitions identified by different partition identifiers. The protocol router or the protocol engine may translate a system address (e.g., <nodeid, physical address) into a unique target device address. The physical address may not be unique across multiple partitions.

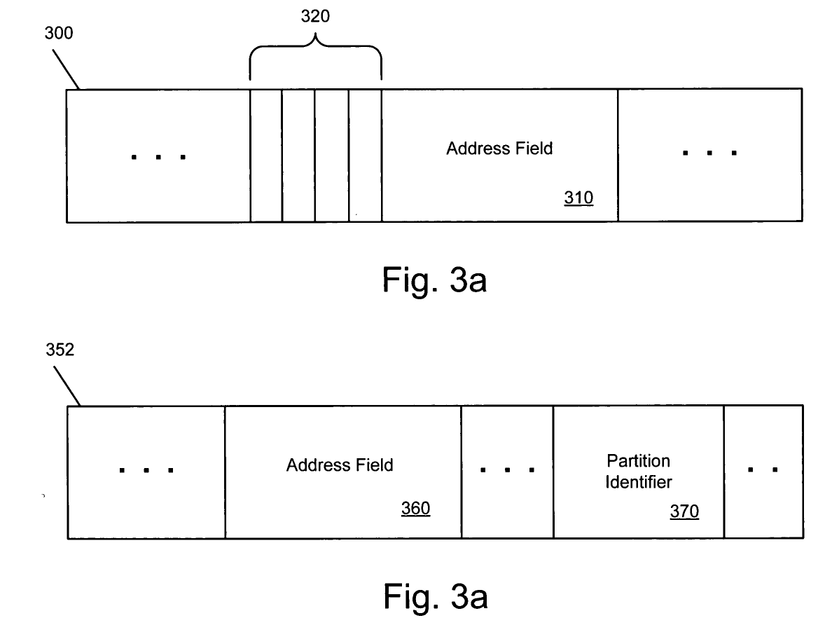

In one embodiment, a protocol packet header may carry a partition identifier that may be used for routing of messages. In one embodiment, the upper four address bits may be used to indicate the partition identifier as illustrated in FIG. 3a. In alternate embodiments, a different number of address bits may be used. In another alternate embodiment, the header may include a field for partition identifier as illustrated in FIG. 3b.

In FIG. 3a, header 300 may have any number of fields including address field 310. A selected number of bits from address field 310 (e.g., the upper 4 bits, the upper 2 bits) may function as a partition identifier 320 to be used as described above. In FIG. 3b, header 350 may have any number of fields including address field 360 and partition identifier field 370. The size of the address fields and/or the partition identifier field may include any number of bits.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope the appended claims. The description is thus to be regarded as illustrative instead of limiting.

What is claimed is:

1. An apparatus comprising:
a first plurality of computing resources coupled with a first hardware interconnection mechanism to route messages between resources corresponding to a partition;
a second plurality of computing resources coupled with a second hardware interconnection mechanism to route messages between resources corresponding to the partition, the second hardware interconnection mechanism coupled with the first interconnection mechanism;
wherein the first hardware interconnection mechanism and the second hardware interconnection mechanism manage partition identifiers corresponding to the first plurality of computing resources and the second plurality of computing resources to route messages between computing resources that belong to corresponding partitions.

2. The apparatus of claim 1 wherein the first plurality of computing resources comprise one or more processing elements and a corresponding memory subsystem.

3. The apparatus of claim 1 wherein the first interconnection mechanism comprises one or more components that interconnect multiple computing resources and direct messages based on partition identifiers.

4. The apparatus of claim 1 wherein the first interconnection mechanism comprises:
an internal interconnect coupled with the first plurality of computing resources, the internal interconnect to route messages based on an internal partition identifier;
a protocol engine coupled with the internal interconnect to manage messages according to a memory coherency protocol, the protocol engine to translate the internal partition identifier to an external partition identifier to be used in messages conforming to the memory coherency protocol; and
a protocol router coupled with the protocol engine to route messages using the external partition identifier.

5. The apparatus of claim 4 wherein the second interconnection mechanism comprises:
an internal interconnect coupled with the second plurality of computing resources, the internal interconnect to route messages based on an internal partition identifier;
a protocol engine coupled with the internal interconnect to manage messages according to a memory coherency protocol, the protocol engine to translate the internal partition identifier to an external partition identifier to be used in messages conforming to the memory coherency protocol; and
a protocol router coupled with the protocol engine to route messages using the external partition identifier.

6. The apparatus of claim 1 wherein the first plurality of computing resources and the second plurality of computing resources each comprise at least one processor core with an associated cache memory.

7. The apparatus of claim 6 wherein the first plurality of computing resources and the second plurality of computing resources each further comprise at least a memory subsystem having a memory controller.

8. The apparatus of claim 1 wherein the first hardware interconnection mechanism and the second hardware interconnection mechanism each comprise a routing table to store partition identifiers to correspond with resource identifiers to identify resources from the first plurality of computing resources and to identify resources from the second plurality of computing resources.

9. The apparatus of claim 8 wherein the routing tables are configured to store multiple partition identifiers for each resource identifier.

10. The apparatus of claim 8 wherein the first hardware interconnection mechanism and the second hardware interconnection mechanism each further comprise a translation table store a mapping of internal partition identifiers to external partition identifiers.

11. A method comprising:
generating an internal cache request message having an internal partition identifier in response to missing a first cache request corresponding to a requested block of data;
snooping a first set of cache memories in response to the internal cache request message based, at least in part, on the internal partition identifier;
generating an external cache request message having an external partition identifier if the requested block of data is not found in the first set of cache memories; and
routing the external cache request message to one or more computing resources corresponding to a partition based, at least in part, on the external partition identifier.

12. The method of claim 11 wherein routing the external cache request to the one or more computing resources corresponding to the partition based, at least in part, on the external partition identifier comprises:
accessing a routing table using the external partition identifier to determine one or more computing resources corresponding to the partition; and
transmitting the external cache request to the computing resources of the partition.

13. The method of claim 12 further comprising maintaining a mapping of internal partition identifiers to external partition identifiers within a system routing component.

14. A system comprising:
a first plurality of computing resources coupled with a first hardware interconnection mechanism to route messages between resources corresponding to a partition;
a second plurality of computing resources coupled with a second hardware interconnection mechanism to route messages between resources corresponding to the partition, the second hardware interconnection mechanism coupled with the first interconnection mechanism; and
a network interface having a network cable coupled with the first interconnection mechanism and with the second interconnection mechanism;
wherein the first hardware interconnection mechanism and the second hardware interconnection mechanism manage partition identifiers corresponding to the first plurality of computing resources and the second plurality of computing resources to route messages between computing resources that belong to corresponding partitions.

15. The system of claim 14 wherein the first plurality of computing resources comprise one or more processing elements and a corresponding memory subsystem.

16. The system of claim 14 wherein the first interconnection mechanism comprises one or more components that interconnect multiple computing resources and direct messages based on partition identifiers.

17. The system of claim 16 wherein the first interconnection mechanism comprises:
an internal interconnect coupled with the first plurality of computing resources, the internal interconnect to route messages based on an internal partition identifier;
a protocol engine coupled with the internal interconnect to manage messages according to a memory coherency protocol, the protocol engine to translate the internal partition identifier to an external partition identifier to be used in messages conforming to the memory coherency protocol; and
a protocol router coupled with the protocol engine to route messages using the external partition identifier.

18. The system of claim 17 wherein the second interconnection mechanism comprises:
an internal interconnect coupled with the second plurality of computing resources, the internal interconnect to route messages based on an internal partition identifier;
a protocol engine coupled with the internal interconnect to manage messages according to a memory coherency protocol, the protocol engine to translate the internal partition identifier to an external partition identifier to be used in messages conforming to the memory coherency protocol; and
a protocol router coupled with the protocol engine to route messages using the external partition identifier.

19. The system of claim 14 wherein the first plurality of computing resources and the second plurality of computing resources each comprise at least one processor core with an associated cache memory.

20. The system of claim 19 wherein the first plurality of computing resources and the second plurality of computing resources each further comprise at least a memory subsystem having a memory controller.

21. The system of claim 14 wherein the first hardware interconnection mechanism and the second hardware interconnection mechanism each comprise a routing table to store partition identifiers to correspond with resource identifiers to identify resources from the first plurality of computing resources and to identify resources from the second plurality of computing resources.

22. The system of claim 21 wherein the routing tables are configured to store multiple partition identifiers for each resource identifier.

23. The system of claim 21 wherein the first hardware interconnection mechanism and the second hardware interconnection mechanism each further comprise a translation table store a mapping of internal partition identifiers to external partition identifiers.
